(19) United States
(12) Patent Application Publication
(10) Pub. No.: US 2011/0265263 A1
(43) Pub. Date: Nov. 3, 2011

(54) METHOD, SYSTEM AND APPARATUS FOR CARRYING

(76) Inventor: Patricia L. BARTHOLOMEW, Flint Hill, VA (US)

(21) Appl. No.: 13/098,800

(22) Filed: May 2, 2011

Related U.S. Application Data
(60) Provisional application No. 61/329,607, filed on Apr. 30, 2010.

(51) Int. Cl. A61G 1/013

(52) U.S. Cl. 5/627

(57) ABSTRACT

In one exemplary embodiment, a pack is disclosed. The pack may include a portable bag, package or case and may come in a variety of sizes. The pack may be made of a suitable material, for example, canvas, vinyl or plastic. The pack may have, for example, straps, handles, grips or the like. The pack may contain a variety of first aid products and medicine for humans or animals. The pack may also contain a stretcher. The stretcher may be a collapsible stretcher that may fit within at least on storage compartment of the pack.

### CROSS REFERENCE TO RELATED APPLICATIONS

This patent application claims the benefit of priority, under 35 U.S.C. §119, to U.S. Provisional Patent Application No. 61/329,607, filed on Apr. 30, 2010 which is incorporated by reference in its entirety herein.

### BACKGROUND

Many people today own at least one pet that they consider part of the family. When a pet becomes injured or sick, concerned owners will do everything they can to care for them including providing medication, comfort or even visiting a veterinary clinic. While most owners keep pet medicine or first aid materials at home, as well as use the services of a local veterinarian, problems arise if a pet becomes sick or injured in a remote location, for example, on a hike, camping trip, vacation or the like.

For example, a dog, or any other animal, may injure a limb or ingest a harmful substance on a remote hike and become immobile. Some dogs can weigh in excess of 100 lbs, and many owners will find it very difficult to safely move the animal themselves. Furthermore, if the animal has, for example, ingested a poisonous substance, the animal's condition may rapidly deteriorate without quick and proper medication or treatment.

Additionally, when a group of people are, for example, hiking and one member of the group is injured, it can be extremely difficult to move the person from their present location to a location where they may have better access to medical assistance.

### SUMMARY

At least one exemplary embodiment described herein includes a pack method, system and apparatus. In the exemplary method, system and apparatus, a portable pack may, for example, be assembled with a variety of materials and products for treatment or care of a sick or injured human or animal. The pack may have, for example, a collapsible stretcher, first aid materials, medication and the like for treatment and care of a sick or injured human or animal.

### BRIEF DESCRIPTION OF THE FIGURES

Advantages of embodiments of the present invention will be apparent from the following detailed description of the exemplary embodiments thereof, which description should be considered in conjunction with the accompanying drawings in which:

FIG. 1 is an exemplary view of a pack.

FIG. 2 is another exemplary view of an opened pack.

FIG. 3 is another exemplary view of an open pack with an unfolded stretcher.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description, discussion of several terms used herein follows.

The word “exemplary” is used herein to mean “serving as an example, instance, or illustration.” Any embodiment described herein as “exemplary” is not necessarily to be construed as preferred or advantageous over other embodiments. Likewise, the terms “embodiments of the invention,” “embodiments” or “invention” do not require that all embodiments of the method, system or apparatus include the discussed feature, advantage or mode of operation.

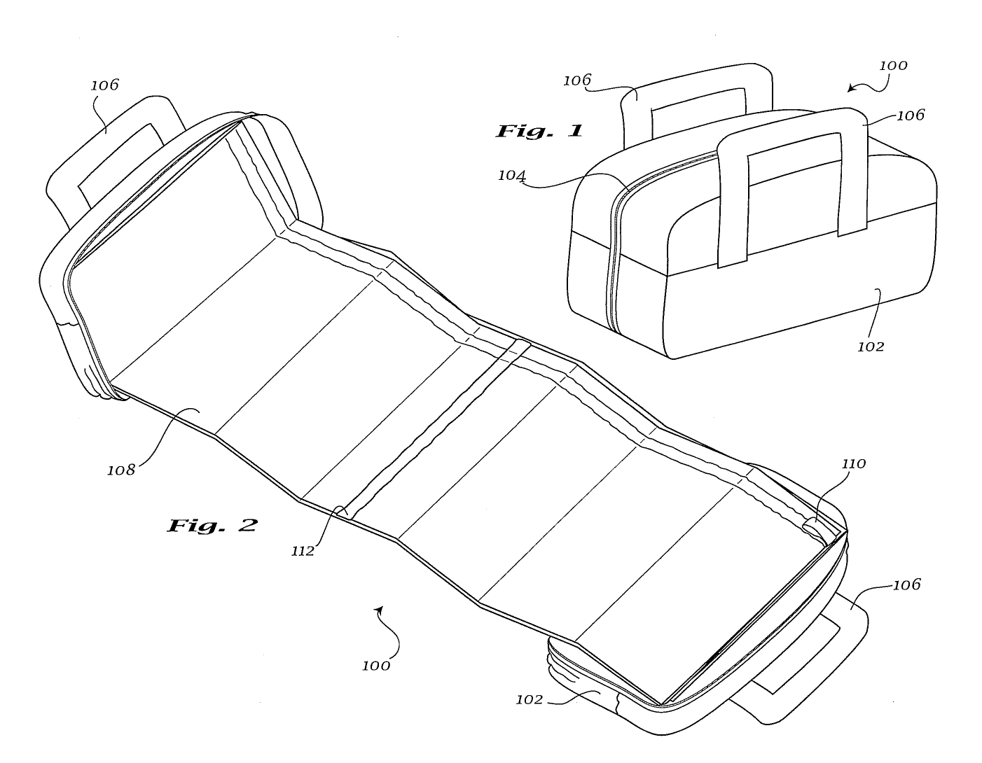

Referring generally to exemplary FIGS. 1-3, a method, system and apparatus for carrying are disclosed. The method, system and apparatus for carrying may include any of a variety of items, including first aid items and a stretcher.

Referring now to exemplary FIG. 1, pack 100 may be a shown. Pack 100 may include, for example, a portable bag, package or case. Pack 100 may come in a variety of sizes. Pack 100 may be made of a suitable material, for example, canvas, vinyl or plastic, or any other material or combination of materials, as desired. For example, in some exemplary embodiments, pack 100 may be formed so as to be substantially water proof or weather proof. For example, pack 100 may be formed with a body 102 in the shape of a bag, suitcase, backpack or any other desired form. Pack 100 may include a zipper 104 on body 102 or any other desired manner or method of closing or sealing pack 100, including, but not limited to buttons, clasps, hook and loop fasteners and the like. Pack 100 may also have, for example, handles 106 or any other form of straps, grips or the like. Pack 100 may further have at least one storage compartment within which and that can be accessed by any suitable means, for example, zipper 104, or any other suitable means as described above. Additionally, when opened, pack 100 may be considered as a housing, a singular storage compartment or may include any desired number of storage compartments, pockets or the like housed within pack 100. Also, in some exemplary embodiments, pack 100 may be carried in any desired fashion, for example, but not limited to, as a bag or hand bag, as a backpack or as a fanny pack. Thus, in some of these exemplary embodiments, the arrangement, orientation, attachment and number of handles 106 may be varied, as desired. For example a backpack can have two shoulder straps and a fanny pack may have a single belt-like strap.

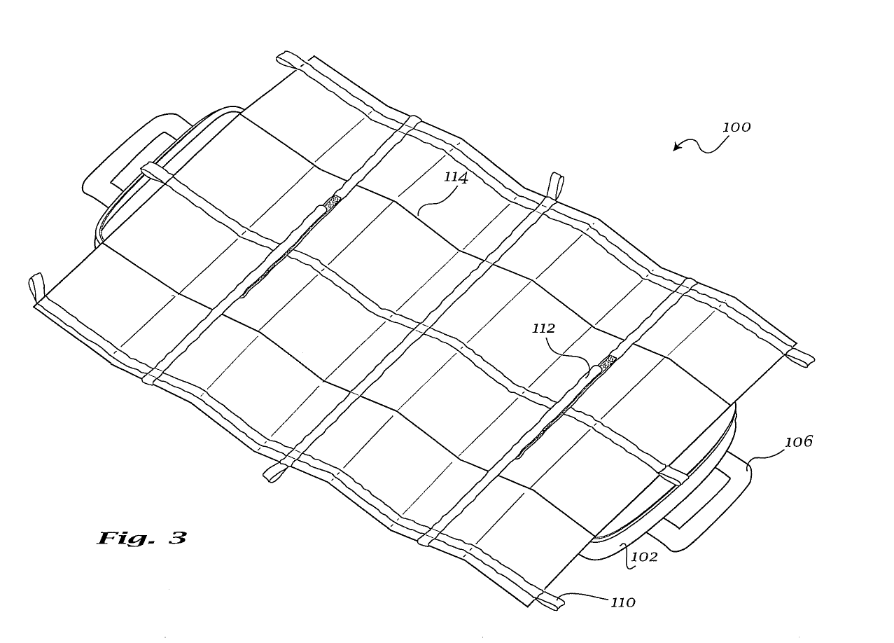

Referring now to exemplary FIGS. 1 and 2, pack 100 may be opened and can contain any variety of first aid products and medicine therein, as well as any other desired items. For example, pack 100 may contain, but is not limited to, a first aid booklet for humans or animals, hot and cold compresses, adhesive tape, latex free gloves, scissors, split rolls, syringes, peroxide, activated charcoal, sterilizing wash, diphenhydramine HCI, eye wash, sterile dressings, rolled gauze bandages, vet wrap, a warming blanket, antibiotic ointment, electrolyte tablets and the like. The amount, size or dosage of the first aid products and medicines may be adjustable, as desired. Additionally, pack 100 can contain any equipment desired to immobilize, tranquilize, or render unconscious an animal. In still other exemplary embodiments, pack 100 may include one or more kits for field dressing an animal. In still further exemplary embodiments, pack 100 may contain any desired materials relevant to or tailored to specific interests or lines of work, for example animal, wildlife or outdoors research, farming, or hunting.

Referring now to exemplary FIG. 2, pack 100 may be opened, for example using zipper 104. After pack 100 is opened, a stretcher 108 may be housed inside pack 100. Stretcher 108 may be a collapsible stretcher that may fit within at least a storage compartment of pack 100. Stretcher 108 may be a variety of shapes or sizes, for example substantially rectangular. Stretcher 108 may be of any suitable, durable material, for example, canvas, vinyl, plastic or the like. Stretcher 108 may be removed from pack 100 and unfolded for use. Alternatively, stretcher 108 may be an integral part of pack 100 that may be unfolded for use. Additionally, stretcher 108 may be removably coupled to an interior compartment of pack 100, for example with any desired combination of a zipper, buttons, clasps or the like. Stretcher 108 may further have any number of segments 114, along which stretcher 108 may be folded and into which any desired reinforcement material may be utilized or coupled.

Stretcher 108 may have, for example, one or more straps 110, handles, grips or the like on one or more sides that may assist in transporting the stretcher. In addition, one or more ends of stretcher 108 may be fastened together which may allow a person to drag stretcher 108. Stretcher 108 may also have straps 112, hook and loop fasteners, buttons, clasps or the like that may nm across stretcher 108 that may help secure the contents or occupant in the stretcher 108. Stretcher 108 may be reusable, and may be folded or collapsed and placed back in pack 100 after any use.

Referring now to exemplary FIG. 3, an exemplary view of pack 100 with stretcher 108 unfolded may be shown. In this example, stretcher 108 may remain integrally attached to pack 100, may be removably coupled to pack 100 or may be separated from pack 100, as described above. Additionally, stretcher 108 can have any number of straps 110, which may be used to help in the carrying or dragging of stretcher 108 when it is occupied by a person or animal, for example. Straps 110 may be positioned at any desired locations on stretcher 108, for example at the corners and center of stretcher 108, thereby distributing the weight that a number of people can carry. Further, if stretcher 108 is coupled to pack 100, handles 106 may also be used to assist in carrying or dragging stretcher 108. It is envisioned that a loaded stretcher 108 may be dragged by one person using any combination of handles 106 and straps 110, or may be carried by any number of people, for example two, four or six people using handles 106 and straps 110 as desired.

Still referring to exemplary FIG. 3, straps 112 may be disposed on stretcher 108 in such a manner as they allow for the securing of a human or animal who is occupying stretcher 108. For example, a first strap 112 may be used to secure the torso, chest and/or arms of a human occupant of stretcher 108 and a second strap 112 may be used to secure the legs or waist of a human occupant. Similarly, if an animal is placed on stretcher 108, a first strap 112 may be used to secure the upper body of the animal and a second strap 112 may be used to secure the lower body of the animal. However, it is envisioned that any number of straps may be disposed at any location of stretcher 108 so as to provide with any desired ability to secure any human, animal or other occupant of stretcher 108.

Still referring to exemplary FIG. 3, stretcher 108, which can be formed out of any material or combination of materials, as desired, can be formed in any size. It is envisioned that pack 100 may be formed having any desired dimensions and capacity, and stretcher 108 may be formed in a complimentary size. Exemplary sizes of stretcher 108 may be such that they would be capable of carrying small animals, such as dogs, or larger animals, such as deer or humans. Further, stretcher 108 may be formed so as to have any desired weight capacity, for example about 40 lbs to about 300 lbs.

The foregoing description and accompanying drawings illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A portable stretcher system, comprising:
a pack, the pack having at least one handle, a sealing mechanism, and a compartment defined within the pack; and
a stretcher housed within the compartment defined in the pack, the stretcher having at least carrying strap and at least one securing strap.

2. The portable stretcher system of claim 1, wherein the stretcher is removably coupled to the compartment defined in the pack.

3. The portable stretcher system of claim 1, wherein the stretcher is formed integrally with the pack.

4. The portable stretcher system of claim 1, further comprising a first aid kit housed in the compartment defined within the pack.

5. The portable stretcher system of claim 1, wherein the pack is formed of at least one of canvas, vinyl or plastic.

6. The portable stretcher system of claim 1, wherein the pack is substantially waterproof.

7. The portable stretcher system of claim 1, wherein the stretcher is formed of at least one of canvas, vinyl or plastic.

8. The portable stretcher system of claim 1, further comprising a field dressing kit housed in the compartment defused within the pack.

9. The portable stretcher system of claim 1, further comprising a tranquilizer kit housed in the compartment defined within the pack.

10. A collapsible stretcher, comprising:
a substantially rectangular piece of material;
at least one handle disposed on a periphery of the substantially rectangular piece of material;
at least one strap disposed across the substantially rectangular piece of material; and
a pack coupled to the substantially rectangular piece of material, wherein the pack is sealable to house the substantially rectangular piece of material.

11. The collapsible stretcher of claim 10, further comprising a compartment in the pack.

12. The collapsible stretcher of claim 11, further comprising a first aid kit housed in the compartment in the pack.

13. The collapsible stretcher of claim 9, wherein the pack is removably coupled to the substantially rectangular piece of material.
